(19) United States
(12) Patent Application Publication
(10) Pub. No.: US 2020/0081334 A1
(43) Pub. Date: Mar. 12, 2020

(54) LIGHT SOURCE DEVICE AND PROJECTOR

(71) Applicant: SEIKO EPSON CORPORATION, Tokyo (JP)

(72) Inventor: Akira EGAWA, Shiojiri-shi (JP)

(73) Assignee: SEIKO EPSON CORPORATION, Tokyo (JP)

(21) Appl. No.: 16/564,362

(22) Filed: Sep. 9, 2019

(30) Foreign Application Priority Data
Sep. 10, 2018 (JP) 2018-169056

(51) Int. Cl. G03B 21/16; G03B 21/20

(52) U.S. Cl. CPC G03B 21/16; G03B 21/2033

(57) ABSTRACT

A light source device includes a light emitting device including a substrate having first and second surfaces opposite each other, light emitting elements at the first surface side, a frame body at the first surface side of the substrate to surround the light emitting elements, and a lid body including a light transmissive member to transmit light emitted from the light emitting elements, disposed so as to be opposed to the first surface of the substrate, and bonded to an opposite side of the frame body to the substrate, and configured to house the light emitting elements in a housing space formed of the substrate, the frame body, and the lid body, an optical element which the light enters, a holding member configured to hold the optical element, and a heat radiation member thermally coupled to the second surface of the substrate, and fixed to the holding member.

The present application is based on, and claims priority from JP Application Serial Number 2018-169056, filed Sep. 10, 2018, the disclosure of which is hereby incorporated by reference herein in its entirety.

### BACKGROUND

### 1. Technical Field

The present disclosure relates to a light source device and a projector.

### 2. Related Art

In recent years, as a light source device used for a projector, what uses a laser beam wide in color gamut and high in efficiency attracts attention. In JP-A-2016-219779, JP-T-2016-518726 (the term “JP-T” as used herein means a published Japanese translation of a PCT patent application), there is disclosed a light source device having a plurality of semiconductor laser elements packaged.

It is required for the light source device having the plurality of semiconductor laser elements packaged as described above to efficiently radiate the heat generated from the semiconductor laser elements. However, in the light source device described above, the cooling performance of the semiconductor laser elements is insufficient.

### SUMMARY

A light source device according to an aspect of the present disclosure includes a light emitting device including a substrate having a first surface and a second surface disposed at an opposite side to the first surface, a plurality of light emitting elements disposed at the first surface side of the substrate, a frame body disposed at the first surface side of the substrate so as to surround the plurality of light emitting elements, and a lid body including a light transmissive member configured to transmit light emitted from the plurality of light emitting elements, disposed so as to be opposed to the first surface of the substrate, and bonded to an opposite side of the frame body to the substrate, and configured to house the plurality of light emitting elements in a housing space formed of the substrate, the frame body, and the lid body, an optical element which the light enters, a holding member configured to hold the optical element, and a heat radiation member thermally coupled to the second surface of the substrate, and fixed to the holding member.

In the light source device according to the aspect of the present disclosure, a surface at an emission direction side of the light of the substrate may touch the holding member, a substrate may be fixed to the holding member, and a part of the substrate may be sandwiched between the holding member and the heat radiation member.

In the light source device according to the aspect of the present disclosure, the second surface of the substrate may touch the holding member. Further, the substrate may be fixed to the heat radiation member, and a part of the substrate may be sandwiched between the holding member and the heat radiation member.

A projector according to another aspect of the present disclosure includes the light source device according to any one of the above aspects of the present disclosure, a light modulation device configured to modulate light emitted from the light source device in accordance with image information, and a projection optical device configured to project the light modulated by the light modulation device.

### BRIEF DESCRIPTION OF THE DRAWINGS

FIG. 1 is a cross-sectional view of a light source device according to a first embodiment.

FIG. 2 is a cross-sectional view of the light source device along the line A-A shown in FIG. 1.

FIG. 3 is a cross-sectional view of the light source device along the line B-B shown in FIG. 2.

FIG. 4 is a perspective view of a light emitting device.

FIG. 5 is a cross-sectional view of the light emitting device.

FIG. 6 is a cross-sectional view of a light source device according to a second embodiment.

FIG. 7 is a cross-sectional view of a light source device according to a third embodiment.

FIG. 8 is a cross-sectional view of a light source device according to a fourth embodiment.

FIG. 9 is a cross-sectional view of a light emitting device in a first modified example.

FIG. 10 is a cross-sectional view of a light emitting device in a second modified example.

FIG. 11 is a diagram showing a schematic configuration of a projector according to a fifth embodiment.

### DESCRIPTION OF EXEMPLARY EMBODIMENTS

### First Embodiment

Some embodiments of the present disclosure will hereinafter be described in detail with reference to the drawings.

In each of the following embodiments, there will be described an example of a light source device suitable to be used for a projector described later.

It should be noted that in all of the following drawings, the constituents may be shown with the scale ratios of respective sizes set differently between the constituents in order to facilitate the visualization of each of the constituents.

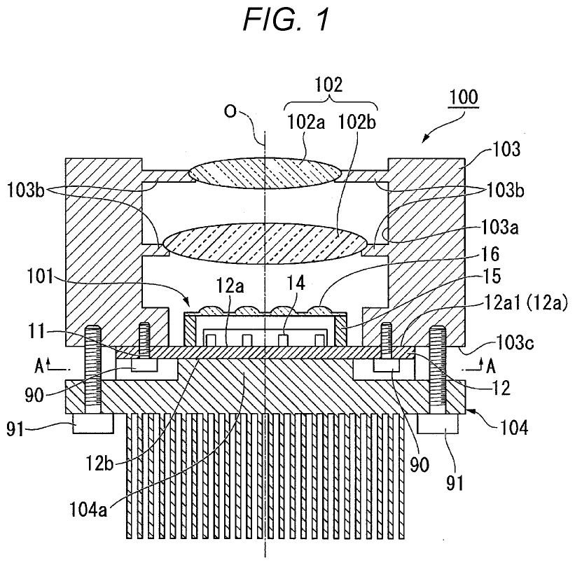

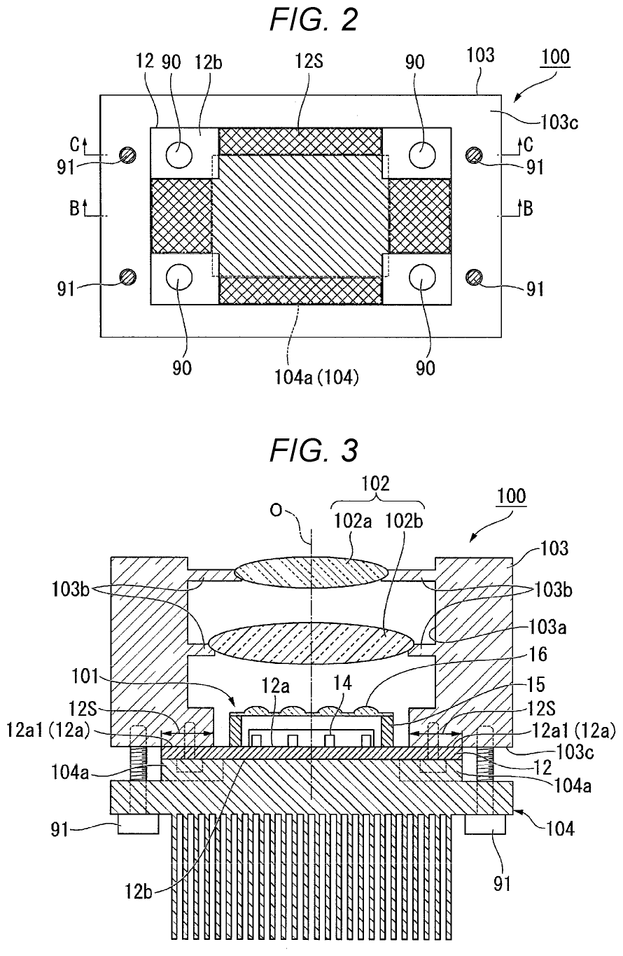

FIG. 1 is a cross-sectional view of a light source device according to a first embodiment. FIG. 2 is a cross-sectional view of the light source device along the line A-A shown in FIG. 1. FIG. 3 is a cross-sectional view of the light source device along the line B-B shown in FIG. 2. It should be noted that FIG. 1 corresponds to a cross-section of the light source device along the line C-C shown in FIG. 2.

As shown in FIG. 1, the light source device 100 according to the first embodiment is provided with a light emitting device 101, an optical element 102, a holding member 103, and a heat radiation member 104, wherein light from the light emitting device 101 enters the optical element 102, the holding member 103 holds the optical element 102, and the heat radiation member 104 is fixed to the holding member 103.

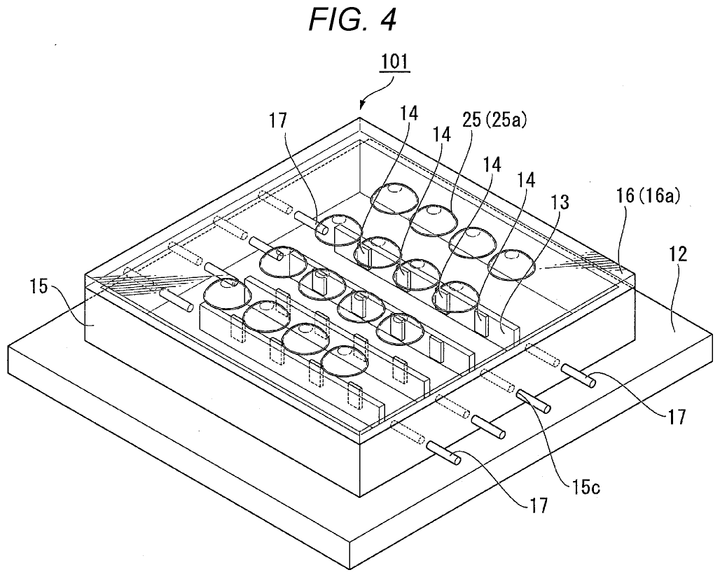

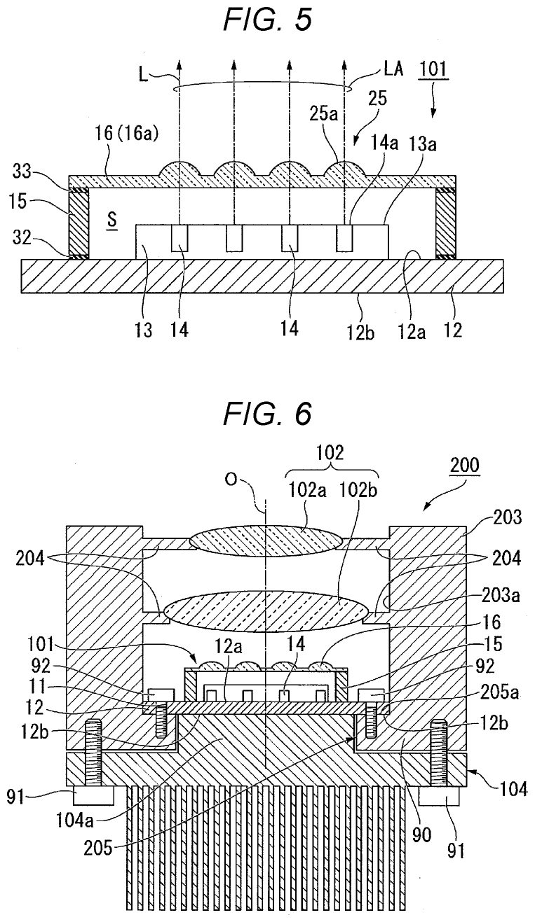

FIG. 4 is a perspective view of the light emitting device. FIG. 5 is a cross-sectional view of the light emitting device.

As shown in FIG. 4, the light emitting device 101 is provided with a substrate 12, a plurality of sub-mounts 13, a plurality of light emitting elements 14, a frame body 15, a lid body 16 and a plurality of lead terminals 17. The substrate 12, the frame body 15 and the lid body 16 are each a separate member, and are bonded to each other as described later.

The substrate 12 is formed of a plate material having an obverse surface (first surface) 12a, and a reverse surface (second surface) 12b located on the opposite side to the obverse surface 12a. The substrate 12 is formed of a metal material high in thermal conductivity. As the metal material of this kind, there is preferably used copper, aluminum or the like, and copper is particularly preferably used.

The substrate 12 has a quadrangular shape such as a substantially square shape or a substantially rectangular shape in a plan view viewed from a normal direction of the obverse surface 12a. On the obverse surface 12a side of the substrate 12, there is disposed a plurality of light emitting elements 14 via a plurality of sub-mounts 13 described later. In the following description, a simple description of a “plan view” denotes a plan view viewed from the normal direction of the obverse surface 12a of the substrate 12.

The plurality of sub-mounts 13 is disposed at predetermined intervals in a direction parallel to one side of the substrate 12 on the obverse surface 12a of the substrate 12. Each of the sub-mounts 13 is disposed so as to correspond to two or more of the light emitting elements 14. In the first embodiment, the sub-mounts 13 are each disposed commonly to the four light emitting elements 14, but the number of the light emitting elements 14 is not particularly limited.

The sub-mounts 13 are each formed of a ceramic material such as aluminum nitride or alumina. The sub-mounts 13 each intervene between the substrate 12 and the light emitting elements 14 to thereby relax the thermal stress generated due to a difference in linear expansion coefficient between the substrate 12 and the light emitting elements 14. The sub-mounts 13 are each bonded to the substrate 12 with a bonding material such as a silver brazing material or gold-tin solder.

The plurality of light emitting elements 14 is disposed at the obverse surface 12a side of the substrate 12. The light emitting elements 14 are each formed of a solid-state light source such as a semiconductor laser or a light emitting diode. As the light emitting elements 14, it is sufficient to use light emitting elements with arbitrary wavelengths in accordance with the intended use of the light source device 100. In the first embodiment, as the light emitting elements 14 for emitting blue light with the wavelength of 430 nm through 490 nm for exciting a phosphor, there are used edge emitting type semiconductor lasers each formed of, for example, a nitride-type semiconductor (In_{X}Al_{Y}Ga_{1-X-Y}, 0≤X≤1, 0≤Y≤1, X+Y≤1). Further, it is also possible to include a compound obtained by displacing some of group-III elements with boron atoms, a compound obtained by displacing some of the nitrogen atoms as group-V elements with phosphorus atoms, arsenic atoms, and so on in addition to the general expression described above.

The plurality of light emitting elements 14 each have a configuration in which, for example, (m×n) (m, n: a natural number no smaller than 2) semiconductor lasers are arranged in an m×n matrix in the plan view. In the first embodiment, as the plurality of light emitting elements 14, there are arranged, for example, 16 semiconductor lasers in a 4×4 matrix.

As shown in FIG. 5, the light emitting elements 14 are each disposed on the sub-mount 13 so that a surface located on an opposite side to a light emitting surface 14a out of the six surfaces of the light emitting element 14 having a rectangular solid shape is opposed to the obverse surface 12a of the substrate 12. According to this arrangement, each of the light emitting elements 14 emits a light beam L in a direction substantially perpendicular to the obverse surface 12a of the substrate 12. Further, the light emitting elements 14 are each disposed on the sub-mount 13 so that the light emission surface 14a is aligned on substantially the same plane as one end surface 13a of the sub-mount 13. The light emitting elements 14 are each bonded to the sub-mount 13 with a bonding material (not shown) such as a silver brazing material or gold-tin solder.

The frame body 15 is disposed so as to surround the plurality of light emitting elements 14, and is bonded on the obverse surface 12a of the substrate 12. Therefore, the frame body 15 is disposed so as to protrude toward the obverse surface 12a side of the substrate 12. The frame body 15 has a quadrangular annular shape in the plan view. The frame body 15 can be a member which has a quadrangular shape and the four sides of which are all integrated with each other, or can also have a configuration having a plurality of members bonded to each other. The frame body 15 keeps the distance (interval) between the substrate 12 and the lid body 16 constant, and constitutes a part of the housing space in which the plurality of light emitting elements 14 is housed. Therefore, it is preferable for the frame body 15 to have predetermined rigidity.

The substrate 12 and the frame body 15 are bonded to each other with the bonding material 32 such as an organic adhesive, a metal bonding material or an inorganic bonding material. As the organic adhesive, there is preferably used, for example, a silicone-based adhesive, an epoxy resin-based adhesive, or an acrylic resin-based adhesive. As the metal bonding material, there is preferably used, for example, a silver brazing material or gold-tin solder. As the inorganic material, there is preferably used, for example, low-melting-point glass.

The frame body 15 fulfills a role for relaxing the stress generated in the lid body 16. Therefore, it is preferable for the frame body 15 to be formed of a material having a linear expansion coefficient lower than the linear expansion coefficient of the substrate 12 and higher than the linear expansion coefficient of the lid body 16. As the material of the frame body 15, there is preferably used a metal material such as Kovar, or a ceramic material such as alumina, silicon carbide, or silicon nitride, and there is particularly preferably used Kovar or alumina.

The lid body 16 is formed of a light transmissive member 16a for transmitting the light beam L emitted from the plurality of light emitting elements 14. The lid body 16 is disposed so as to be opposed to the obverse surface 12a of the substrate 12, and is bonded on an opposite side of the frame body 15 to the substrate 12. The lid body 16 has a quadrangular shape including a square shape and a rectangular shape in the plan view.

The lid body 16 and the frame body 15 are bonded to each other with the bonding material 33 such as an organic adhesive, a metal bonding material or an inorganic bonding material. As the organic adhesive, there is preferably used, for example, a silicone-based adhesive, an epoxy resin-based adhesive, or an acrylic resin-based adhesive. As the metal bonding material, there is preferably used, for example, a silver brazing material or gold-tin solder. As the inorganic material, there is preferably used, for example, low-melting-point glass.

The light transmissive member 16a constituting the lid body 16 is a plate like member using a material having a light transmissive property as a constituent material. As such a constituent material, there can be cited glass such as borosilicate glass, quartz glass, or quart glass, quartz crystal, sapphire, and so on.

In the lid body 16 of the first embodiment, the collimating lens unit 25 is integrally formed on a surface at the opposite side of the lid body 16 to the substrate 12. The collimating lens unit 25 has a plurality of lenses 25a arranged so as to correspond to the respective light emitting elements 14. In other words, the collimating lens unit 25 has the same number (sixteen in the first embodiment) of lenses 25a as the number of the light emitting elements 14. Each of the condenser lenses 25a is formed of a plano-convex lens. Each of the lenses 25a of the collimating lens unit 25 collimates the light beam L emitted from the light emitting element 14.

By the substrate 12, the frame body 15, and the lid body 16 being bonded to each other, the space surrounded by the substrate 12, the frame body 15, and the lid body 16 becomes an enclosed space which is blocked off from the ambient air, and in which the plurality of light emitting elements 14 is airtightly housed. Hereinafter, the enclosed space is referred to as a housing space S. In other words, the plurality of light emitting elements 14 is housed in the housing space S formed by the substrate 12, the frame body 15, and the lid body 16.

By the plurality of light emitting elements 14 being housed in the housing space S, adherence of foreign matters such as organic substances or moisture to the light emitting elements 14 is reduced. It is preferable for the housing space S to be in a reduced pressure state. Alternatively, it is possible for the housing space S to be filled with an inert gas such as nitrogen gas, or dry air. It should be noted that the reduced pressure state denotes a state of a space filled with a gas in the pressure lower than the atmospheric pressure. In the reduced pressure state, the gas with which the housing space S is filled is preferably the inert gas or the dry air.

As shown in FIG. 4, the frame body 15 is provided with a plurality of through holes 15c. In each of the through holes 15c, there is disposed the lead terminal 17 for supplying each of the light emitting elements 14 with electrical power. As a constituent material of the lead terminals 17, there is used Kovar, for example. On the surface of each of the lead terminals 17, there is disposed a plated layer made of, for example, nickel-gold.

In the housing space S, there are disposed bonding wires (not shown) each for electrically connecting one end of the lead terminal 17 and the terminal of the light emitting element 14 to each other. The other end of the lead terminal 17 is connected to an external circuit (not shown). A gap between an inner wall of the through hole 15c of the frame body 15 and the lead terminal 17 is sealed with a sealing material. As the sealing material, low-melting-point glass, for example, is preferably used.

Based on such a configuration, the light emitting device 101 is arranged to emit a blue pencil LA having the plurality of light beams L collimated.

Going back to FIG. 1, the blue pencil LA having been emitted from the light emitting device 101 enters the optical element 102. The optical element 102 is provided with a first lens 102a and a second lens 102b. The optical element 102 makes the blue pencil LA having been emitted from the light emitting device 101 enter the illumination area in substantially converged state. The first lens 102a and the second lens 102b are each formed of a convex lens. In the first embodiment, the optical element 102 functions as a light collection optical system for converging the blue pencil LA.

The optical element 102 is held by the holding member 103. The holding member 103 is a cylindrical member extending along a direction of a central axis O. The holding member 103 has holding part 103b each extending inward from an inner surface 103a to hold the optical element 102. The holding parts 103b hold the first lens 102a and the second lens 102b constituting the optical element 102 at predetermined positions, respectively. In the first embodiment, the holding member 103 can be formed of a single member, or can also be constituted by a plurality of parts. In the latter case, even when the structure of the holding member 103 becomes complicated, for example, it is possible to obtain the holding member 103 having a desired shape by assembling the parts.

Further, the holding member 103 in the first embodiment holds the light emitting device 101 on an end surface 103c on one end side in the direction along the central axis O. The light emitting device 101 is fixed to the end surface 103c of the holding member 103 via first screw members 90 in a state in which the frame body 15 and the lid body 16 are inserted in the holding member 103. The substrate 12 of the light emitting device 101 is provided with through holes 11 through which the first screw members 90 are inserted. A touching surface 12a1 (a surface at the emission direction side of the light beam L) as a part of the obverse surface 12a of the substrate 12 touches the end surface 103c of the holding member 103. It should be noted that although in the first embodiment, there is described when the touching surface 12a1 touching the end surface 103c becomes the same surface as, namely coplanar with, the obverse surface 12a held by the light emitting elements 14, it is also possible for the touching surface 12a1 to be a surface not coplanar with, but different in height from, the obverse surface 12a. In other words, the touching surface 12a1 and the obverse surface 12a can be formed of respective surfaces different from each other.

In the light source device 100 according to the first embodiment, by fixing the optical element 102 and the light emitting device 101 to the holding member 103, it is possible to improve the positional accuracy between the optical element 102 and the light emitting device 101.

The heat radiation member 104 is a member for radiating the heat from the light emitting device 101. Specifically, the heat radiating member 104 is formed of, for example, a heatsink. The heat radiation member 104 has a coupling section 104a to be thermally coupled to the reverse surface 12b of the substrate 12 of the light emitting device 101, and is fixed to the holding member 103 in the state in which the coupling section 104a is thermally coupled to the reverse surface 12b. In the first embodiment, the heat radiation member 104 is fixed to the holding member 103 via second screw members 91.

Here, the expression of “thermally coupled” is not limited to a configuration in which the heat radiation member 104 and the reverse surface 12b of the substrate 12 are directly coupled to each other, but is a concept including a configuration in which the substrate 12 and the heat radiation member 104 are coupled to each other so that the heat of the substrate 12 can be transferred toward the heat radiation member 104. Specifically, in the first embodiment, thermally-conductive grease not shown is disposed between the heat radiation member 104 and the reverse surface 12b of the substrate 12, and the heat radiation member 104 and the substrate 12 are thermally coupled to each other via the thermally-conductive grease.

In the light source device 100 according to the first embodiment, by thermally coupling the coupling section 104a of the heat radiation member 104 to the reverse surface 12b different from the obverse surface 12a of the substrate to which the heat radiation member 104 contacts, the large cooling area is ensured in the substrate 12.

Incidentally, in the light source device 100 according to the first embodiment, the substrate 12 of the light emitting device 101 is formed of a soft material such as copper or aluminum high in thermal conductivity. Therefore, there is a possibility that when the heat radiation member 104 applies high pressure to the reverse surface 12b of the substrate 12, the light emitting device 101 deforms, and thus, the optical axis of the blue pencil LA from the light emitting device 101 with respect to the optical element 102 held by the holding member 103 is shifted to make it unachievable for the optical element 102 to converge the blue pencil LA at a desired position to decrease the light use efficiency of the blue pencil LA.

In contrast, in the light source device 100 according to the first embodiment, a part of the substrate 12 is held so as to be sandwiched between the holding member 103 and the heat radiation member 104. Specifically, as shown in FIG. 2 and FIG. 3, the substrate 12 has a sandwiched area 12S sandwiched between the holding member 103 and the heat radiation member 104. Thus, since the part (the sandwiched area 12S) of the substrate 12 is sandwiched between the holding member 103 and the coupling section 104a of the heat radiation member 104, the light emitting device 101 becomes to be held with respect to the holding member 103 in good condition.

Therefore, according to the light source device 100 related to the first embodiment, since the light emitting device 101 is stably held without deforming, a problem that the optical axis is shifted between the blue pencil LA emitted from the light emitting device 101 and the optical element 102 held by the holding member 103 can be prevented from occurring.

According to the light source device 100 related to the first embodiment described hereinabove, the following advantages are exerted.

The light source device 100 according to the first embodiment is provided with the light emitting device 101, the optical element 102, the holding member 103, and the heat radiation member 104, wherein the light emitting device 101 has the substrate 12, the plurality of light emitting elements 14, the frame body 15, and the lid body 16, the substrate 12 has the obverse surface 12a and the reverse surface 12b disposed at the opposite side to the obverse surface 12a, the plurality of light emitting elements 14 is disposed at the obverse surface 12a side of the substrate 12, the frame body 15 is disposed at the obverse surface 12a side of the substrate 12 so as to surround the plurality of light emitting elements 14, the lid body 16 includes the light transmissive member 16a for transmitting the light beams L emitted from the plurality of light emitting elements 14, disposed so as to be opposed to the obverse surface 12a of the substrate 12, and is bonded to the frame body 15 on the opposite side to the substrate 12, the plurality of light emitting elements 14 is housed in the housing space S formed by the substrate 12, the frame body 15, and the lid body 16, the light beams L enter the optical element 102, the holding member 103 holds the optical element 102, and the heat radiation section 104 is thermally coupled to the reverse surface 12b of the substrate 12, and is fixed to the holding member 103.

Thus, in the light source device 100 according to the first embodiment, by thermally coupling the substrate 12 to the heat radiation member 104 on the reverse surface 12b which is different from the obverse surface of the substrate 12 having contact with the heat radiation member 104, the large cooling area is ensured in the substrate 12, and therefore, the cooling performance of the light emitting device 101 is enhanced.

Further, in the light source device 100 according to the first embodiment, by fixing the optical element 102 and the light emitting device 101 to the holding member 103, it is possible to improve the positional accuracy between the optical element 102 and the light emitting device 101.

Further, in the light source device 100 according to the first embodiment, since the positional accuracy between the optical element 102 and the light emitting device 101 can be improved, it is possible to make the light beams L emitted from the plurality of light emitting elements 14 enter the desired positions in a wavelength conversion element 50 described later.

Further, in the light source device 100 according to the first embodiment, the touching surface 12a1 of the substrate 12 touches the holding member 103, the substrate 12 is fixed to the holding member 103, and the part of the substrate 12 is sandwiched between the holding member 103 and the heat radiation member 104.

According to this configuration, since it is possible to stably hold the light emitting device 101 without deforming, the displacement between the light emitting device 101 and the optical element 102 due to the deformation of the light emitting device 101 is prevented, and therefore, it is possible to make the blue pencil LA emitted from the light emitting device 101 efficiently enter the optical element 102.

### Second Embodiment

Subsequently, a light source device according to a second embodiment will be described. It should be noted that constituents and members common to the first embodiment will be denoted by the same reference symbols, and the detailed description thereof will be omitted.

FIG. 6 is a cross-sectional view of the light source device according to the second embodiment. As shown in FIG. 6, the light source device 200 according to the second embodiment is provided with the light emitting device 101, the optical element 102, a holding member 203, and the heat radiation member 104.

The optical element 102 is held by the holding member 203. The holding member 203 is a cylindrical member extending along the direction of the central axis O. The holding member 203 has first holding parts 204 for holding the optical element 102, and a second holding part 205 for holding the light emitting device 101. The first holding parts 204 each extend inward from an inner surface 203a of the holding member 203. The second holding part 205 is disposed at one end side in a direction along the central axis O with respect to the first holding parts 204, and is disposed so as to project inward from the inner surface 203a of the holding member 203.

In the second embodiment, the holding member 203 can be formed of a single member, or can also be constituted by a plurality of parts. In the second embodiment, for example, by forming the first holding parts 204 and the second holding part 205 as separate bodies, it becomes easy to assemble the holding member 203.

The second holding part 205 has a holding surface 205a for holding the light emitting device 101. The reverse surface 12b of the substrate 12 of the light emitting device 101 touches the holding surface 205a. In the second embodiment, the light emitting device 101 is attached to the holding surface 205a of the second holding part 205 via third screw members 92 in a state of being inserted inside the holding member 203. The third screw members 92 are respectively inserted through the through holes 11 of the substrate 12 of the light emitting device 101.

The heat radiation member 104 is fixed to the holding member 103 in a state in which the coupling section 104a is thermally coupled to the reverse surface 12b. In the second embodiment, the heat radiation member 104 is fixed to the holding member 203 via the second screw members 91.

Here, since the heat generated in the light emitting elements 14 spreads on the substrate 12, the area of a region where the temperature rises in the substrate 12 becomes larger than the area of a region where the light emitting elements 14 are mounted.

In the second embodiment, the area of a region where the coupling section 104a has thermally contact with the reverse surface 12b is made larger than the area of the region where the plurality of light emitting elements 14 is mounted in the light emitting device 101. Specifically, in the second embodiment, the area of the region where the coupling section 104a has thermally contact with the reverse surface 12b is made larger than an exterior shape of the frame body 15 surrounding the plurality of light emitting elements 14.

Thus, since it is possible to efficiently discharge the heat generated in the plurality of light emitting elements 14 from the reverse surface 12b of the substrate 12 with the heat radiation member 104, the heat radiation performance of the light emitting device 101 can be improved.

In the light source device 200 according to the second embodiment, a part of the reverse surface 12b of the substrate 12 which the heat radiation member 104 has contact with is fixed to the holding member 203 (a holding surface 205a). In other words, the holding member 203 and the heat radiation member 104 have contact with the same surface (the reverse surface 12b) of the substrate 12.

Here, there will be considered when mounting the reverse surface 12b of the substrate 12 on an assembling jig when mounting the plurality of light emitting elements 14 on the substrate 12 in the manufacturing process of the light emitting device 101. In this case, when assembling the light emitting device 101, the reverse surface 12b of the substrate 12 becomes the reference surface of the alignment when assembling the parts.

In the light source device 200 according to the second embodiment, the reverse surface 12b of the substrate 12 which is used as the reference surface when assembling the light emitting device 101 is fixed to the holding member 203 (the holding surface 205a). Therefore, the light emitting elements 14 of the light emitting device 101 are accurately arranged with respect to the holding member 203. Therefore, it is possible to improve the positional accuracy between the light emitting elements 14 and the optical element 102. Further, in the light source device 200 according to the second embodiment, since the positional accuracy between the optical element 102 and the light emitting device 101 can be improved, it is possible to make the light beams L emitted from the plurality of light emitting elements 14 enter the desired positions in the wavelength conversion element 50 described later.

Further, the reverse surface 12b of the substrate 12 of the light emitting device 101 is near to the mounting surface (the obverse surface 12a) of the light emitting elements 14. In the light source device 200 of the second embodiment, since the heat radiation member 104 is thermally coupled to the reverse surface 12b of the substrate 12, it is possible to improve the cooling performance of the light emitting device 101.

Therefore, according to the light source device 200 related to the second embodiment, by disposing the holding member 203 and the heat radiation member 104 on the reverse surface 12b of the substrate 12, it is possible to achieve both of the improvement in positional accuracy between the light emitting elements 14 and the optical element 102 and the improvement in cooling performance of the light emitting device 101.

As described above, also in the light source device 200 according to the second embodiment, it is possible to obtain substantially the same advantages as in the first embodiment. In other words, it is possible to obtain an advantage that the cooling performance of the light emitting device 101 can be improved.

### Third Embodiment

Subsequently, a light source device according to a third embodiment will be described. The light source device according to the third embodiment has a common configuration to the light source device 200 according to the second embodiment except the fact that the fixation method of the light emitting device 101 is different. Therefore, constituents and members common to the second embodiment will be denoted by the same reference symbols, and the detailed description thereof will be omitted.

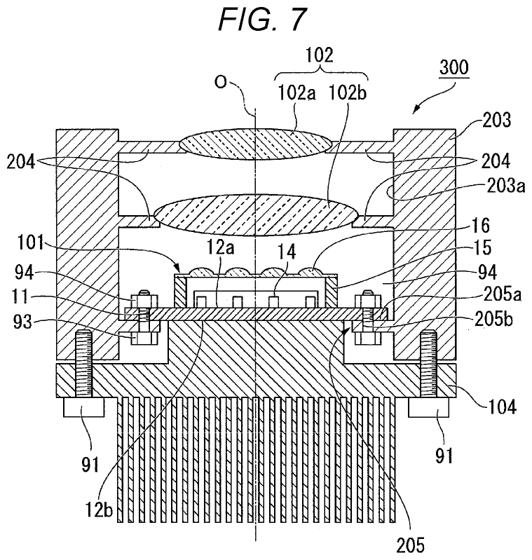

FIG. 7 is a cross-sectional view of the light source device according to the third embodiment. As shown in FIG. 7, the light source device 300 according to the third embodiment is provided with the light emitting device 101, the optical element 102, the holding member 203, and the heat radiation member 104.

The light emitting device 101 in the third embodiment is attached to the holding surface 205a of the holding member 203 via fourth screw members 93 and fixation members 94. In the third embodiment, the fourth screw members 93 are inserted into through holes 205b provided to the second holding part 205 of the holding member 203 from the lower side (the heat radiation member 104 side), and at the same time inserted through the through holes 11 of the substrate 12 of the light emitting device 101, respectively. Then, by fixing the fourth screw members 93 projecting from the through holes 11 with, for example, screw fixation members 94 such as nuts, the reverse surface 12b of the substrate 12 of the light emitting device 101 is fixed to the holding surface 205a of the second holding part 205. It should be noted that in the third embodiment, for the sake of expediency of inserting the fourth screw members 93, the thickness in the second holding part 205 is made thinner compared to the configuration of the second embodiment.

In the third embodiment, the light emitting device 101 is held by being sandwiched between the holding surface 205a and the screw fixation members 94. Therefore, in the light source control device 300 according to the third embodiment, since the light emitting device 101 can be fixed by being pressed with the surface, the light emitting device 101 can stably be held by the holding member 203 while preventing the deformation from occurring.

As described above, also in the light source device 300 according to the third embodiment, it is possible to obtain substantially the same advantages as in the second embodiment. Specifically, by disposing the holding member 203 and the heat radiation member 104 on the reverse surface 12b of the substrate 12, it is possible to obtain both of the positional accuracy between the light emitting elements 14 and the optical element 102, and the cooling performance of the light emitting device 101. Further, in the light source device 300 according to the third embodiment, since the positional accuracy between the optical element 102 and the light emitting device 101 can be improved, it is possible to make the light beams L emitted from the plurality of light emitting elements 14 enter the desired positions in the wavelength conversion element 50 described later.

Further, according to the light source device 300 related to the third embodiment, since the fixation of the light emitting device 101 to the holding member 203 with the third screw members 92, and the fixation of the heat radiation member 104 to the holding member 203 with the second screw members 91 can both be performed from one side of the holding member 103, it is possible to improve the workability in assembling the light source device 300.

### Fourth Embodiment

Subsequently, a light source device according to a fourth embodiment will be described. It should be noted that constituents and members common to the first embodiment will be denoted by the same reference symbols, and the detailed description thereof will be omitted.

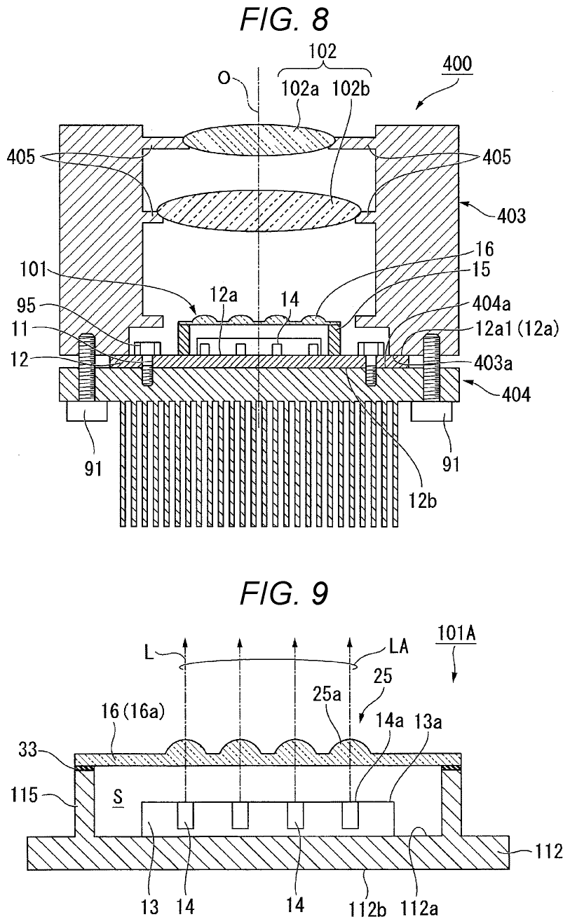

FIG. 8 is a cross-sectional view of the light source device according to the fourth embodiment. As shown in FIG. 8, the light source device 400 according to the fourth embodiment is provided with the light emitting device 101, the optical element 102, a holding member 403, and a heat radiation member 404.

In the fourth embodiment, the heat radiation member 404 has a coupling surface 404a to be thermally coupled to the reverse surface 12b of the substrate 12 of the light emitting device 101, and is fixed to the holding member 403 in the state in which the coupling surface 404a is thermally coupled to the reverse surface 12b. The holding member 403 has holding parts 405 for holding the optical element 102.

In the heat radiation member 404 in the fourth embodiment, the area of the coupling surface 404a is larger than the area of the reverse surface 12b of the substrate 12 of the light emitting device 101. Therefore, the light emitting device 101 is fixed to the coupling surface 404a of the heat radiation member 404 via fifth screw members 95. The fifth screw members 95 are respectively inserted through the through holes 11 provided to the substrate 12 of the light emitting device 101. Further, the heat radiation member 404 is fixed to the holding member 403 via the second screw members 91.

Further, the touching surface 12a1 (the surface at the emission direction side of the light beam L) as a part of the obverse surface 12a of the substrate 12 touches an end surface 403a of the holding member 403. The holding member 403 in the fourth embodiment is prevented from having contact with the fifth screw members 95 by cutting out a part of the end surface 403a. In the light source device 400 according to the fourth embodiment, a part of the substrate 12 is sandwiched between the holding member 403 and the heat radiation member 404.

It should be noted that in the fourth embodiment, the holding member 403 can be formed of a single member, or can also be constituted by a plurality of parts.

According to the light source device 400 related to the fourth embodiment, since the area of the coupling surface 404a of the heat radiation member 404 is made larger than the area of the reverse surface 12b of the substrate 12 of the light emitting device 101, it is possible to fix the light emitting device 101 to the heat radiation member 404. Thus, by increasing the contact area between the light emitting device 101 and the heat radiation member 404, it is possible to decrease the contact thermal resistance. Therefore, it is possible to efficiently radiate the heat from the light emitting device 101.

Further, in the light source device 400 according to the fourth embodiment, by holding the part of the substrate 12 so as to be sandwiched, the pressing force is applied between the reverse surface 12b of the substrate 12 and the coupling surface 404a of the heat radiation member 404. Therefore, since the contact area between the reverse surface 12b and the coupling surface 404a further increases, it is possible to further reduce the contact thermal resistance.

Further, in the light source device 400 according to the fourth embodiment, since the light emitting device 101 is fixed to the holding member 403 in good condition, it is possible to position the light emitting device 101 with respect to the optical element 102 fixed to the holding member 403. Therefore, the positional accuracy between the optical element 102 and the light emitting device 101 is improved. Further, in the light source device 400 according to the fourth embodiment, since the positional accuracy between the optical element 102 and the light emitting device 101 can be improved, it is possible to make the light beams L emitted from the plurality of light emitting elements 14 enter the desired positions in the wavelength conversion element 50 described later.

As described above, according to the light source device 400 related to the fourth embodiment, it is possible to achieve both of the improvement in positional accuracy between the light emitting elements 14 and the optical element 102, and the improvement in cooling performance of the light emitting device 101.

### First Modified Example

Subsequently, a light emitting device according to a first modified example will be described. The light emitting device according to the first modified example is substantially the same in basic configuration as that of the first embodiment, but is different in the configuration of the substrate from that of the first embodiment. Therefore, the description of the whole of the light emitting device will be omitted, and only the configuration different from that of the first embodiment will be described.

FIG. 9 is a cross-sectional view of a light emitting device in the first modified example. In FIG. 9, the constituents common to the drawing used in the first embodiment are denoted by the same reference symbols, and the description thereof will be omitted.

As shown in FIG. 9, the light emitting device 101A in the first modified example is provided with a substrate 112, the plurality of sub-mounts 13, the plurality of light emitting elements 14, the lid body 16 and the plurality of lead terminals (not shown).

The substrate 112 is formed of a plate material having an obverse surface (first surface) 112a, a reverse surface 112b, and a frame body 115 disposed on the obverse surface 112a. On the obverse surface 112a side of the substrate 112, there is disposed the plurality of light emitting elements 14 via the plurality of sub-mounts 13.

The frame body 115 is disposed so as to protrude on the obverse surface 112a of the substrate 112. The frame body 115 is disposed integrally with the substrate 112 so as to surround the plurality of light emitting elements 14. Similarly to the frame body 15 in the first embodiment, the frame body 115 keeps the distance (interval) between the substrate 112 and the lid body 16 constant to constitute a part of the housing space S in which the plurality of light emitting elements 14 is housed. The substrate 112 is formed of a metal material high in thermal conductivity such as copper or aluminum. In other words, the frame body 115 also functions as the frame body 15 in the first embodiment.

The lid body 16 is disposed so as to be opposed to the obverse surface 112a of the substrate 112, and is bonded to an upper surface of the frame body 115 protruding from the obverse surface 112a with a bonding material 33 such as an organic adhesive, a metal bonding material, or an inorganic bonding material.

According to the light emitting device 101A in the first modified example, it is possible to obtain substantially the same advantages as those of the first embodiment. Specifically, it is possible to obtain the advantage that the cooling performance of the light emitting device 101A can be improved. In particular, in the case of the first modified example, since the substrate 112 and the frame body 115 are integrated as a single member, it is possible to further simplify the configuration of the light emitting device.

### Second Modified Example

Subsequently, a light emitting device according to a second modified example will be described. The light emitting device according to the second modified example is substantially the same in basic configuration as that of the first embodiment, but is different in the configuration of the lid body from that of the first embodiment. Therefore, the description of the whole of the light emitting device will be omitted, and only the configuration different from that of the first embodiment will be described.

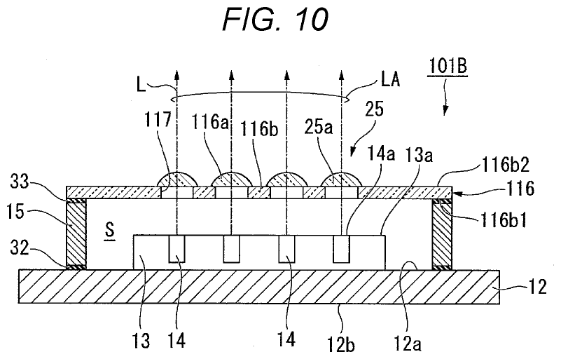

FIG. 10 is a cross-sectional view of a light emitting device in the second modified example. In FIG. 10, the constituents common to the drawing used in the first embodiment are denoted by the same reference symbols, and the description thereof will be omitted.

As shown in FIG. 10, the light emitting device 101B in the second modified example is provided with the substrate 12, the plurality of sub-mounts 13, the plurality of light emitting elements 14, the lid body 15, a lid body 116, and the plurality of lead terminals (not shown).

The lid body 116 in the second modified example has a plurality of lenses 116a and a support member 116b to which the plurality of lenses 116a is bonded. In the second modified example, the plurality of lenses 116a is bonded to an upper surface 116b2 opposite to a lower surface 116b1 opposed to the obverse surface 12a of the substrate 12 out of the two surfaces of the support member 116b.

The support member 116b is formed of a rectangular plate material in the plan view, and has opening sections 117 at positions corresponding to paths of the light beams L emitted from the light emitting elements 14, respectively. In other words, the support member 116b has the same number of the opening sections 117 as the number of the light emitting elements 14. The support member 116b is bonded on the opposite side of the frame body 15 to the substrate 12. The support member 116b is formed of a metal material such as copper or aluminum. It is also possible to dispose a plating layer made of, for example, nickel on a surface of the support member 116b. Alternatively, it is also possible for the support member 116b to be formed of a resin material.

Each of the lenses 116a is formed of a plano-convex lens made of a light transmissive material. The lens 116a formed of the plano-convex lens has a function of collimating the light beam L emitted from the light emitting element 14. The lenses 116a each have external dimensions one-size larger than those of the opening section 117 of the support member 116b in the plan view.

It should be noted that when there is no need for the lid body to have refractive power, it is sufficient to adopt a configuration of bonding a flat plate having a light transmissive property to each of the opening sections 117. Further, it is also possible for each of the lenses 116a to be bonded to the lower surface 116b1 of the support member 116b. According to this configuration, since the distance between the light emitting elements 14 and the respective lenses 116a shortens, the beam width of the light beam L collimated by the lens 116a becomes smaller.

According to the light emitting device 101B in the second modified example, it is possible to obtain substantially the same advantages as those of the first embodiment. Specifically, it is possible to obtain the advantage that the cooling performance of the light emitting device 101B can be improved. In particular, in the case of the second modified example, since the lenses 116a and the support member 116b are formed as the separate members, the installation positions of the respective lenses 116a with respect to the support member 116b can be adjusted. Therefore, it is possible to accurately align the lenses 116a and the light emitting elements 14 with each other. Therefore, it is possible for the lenses 116a to accurately take out the light beams L emitted from the light emitting elements 14, respectively.

### Fifth Embodiment

Although an example of a projector will hereinafter be described as a fifth embodiment, the embodiment of the projector is not limited to this example.

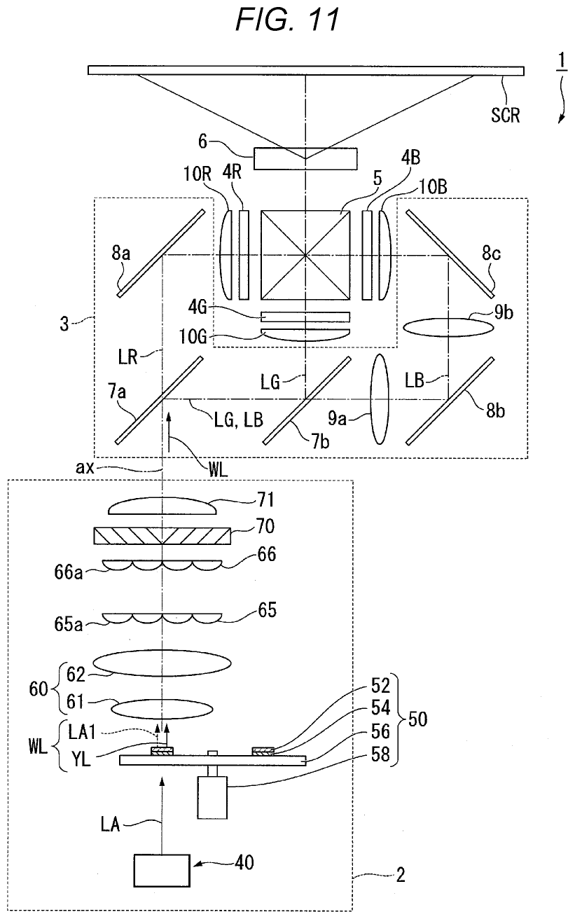

FIG. 11 is a diagram showing a schematic configuration of the projector according to the fifth embodiment.

As shown in FIG. 11, the projector 1 according to the fifth embodiment is a projection-type image display device for displaying a color image on a screen SCR. The projector 1 is provided with an illumination device 2, a color separation optical system 3, a light modulation device 4R, a light modulation device 4G, a light modulation device 4B, a combining optical device 5, and a projection optical device 6.

Illumination light WL as white light is emitted from the illumination device 2. The color separation optical system 3 separates the illumination light WL as the white light into red light LR, green light LG, and blue light LB. It should be noted that the red light LR denotes visible red light having a peak wavelength no less than 590 nm and no more than 700 nm, the green light LG denotes visible green light having a peak wavelength no less than 500 nm and no more than 590 nm, and the blue light LB denotes visible blue light having a peak wavelength no less than 400 nm and no more than 500 nm.

The color separation optical system 3 is provided with a first dichroic mirror 7a and a second dichroic mirror 7b, a first total reflection mirror 8a, a second total reflection mirror 8b, and a third total reflection mirror 8c. The first dichroic mirror 7a separates the illumination light WL from the illumination device 2 into the red light LR and the other light (the blue light LB and the green light LG). The first dichroic mirror 7a reflects the blue light LB and the green light LG, and transmits the red light LR. The second dichroic mirror 7b reflects the green light LG, and at the same time, transmits the blue light LB.

The first total reflection mirror 8a reflects the red light LR toward the light modulation device 4R. The second total reflection mirror 8b and the third total reflection mirror 8c guide the blue light LB to the light modulation device 4B. The green light LG is reflected by the second dichroic mirror 7b toward the light modulation device 4G.

A first relay lens 9a and a second relay lens 9b are disposed in a posterior stage of the second dichroic mirror 7b in the light path of the blue light LB.

The light modulation device 4B modulates the blue light LB in accordance with image information to form blue image light.

The light modulation device 4G modulates the green light LG in accordance with the image information to form green image light. The light modulation device 4R modulates the red light LR in accordance with image information to form red image light. As the light modulation devices 4B, 4G, and 4R, there are used, for example, transmissive liquid crystal panels.

On the incident side and the exit side of each of the light modulation devices 4B, 4G, and 4R, there are respectively disposed polarization plates not shown. Further, on the incident side of the light modulation devices 4B, 4G and 4R, there are respectively disposed field lenses 10B, 10G, and 10R.

The image light from each of the light modulation devices 4B, 4G, and 4R enters the combining optical system 5. The combining optical device 5 combines the blue image light, the green image light, and the red image light with each other, and then emits the image light thus combined toward the projection optical device 6. The combining optical device 5 has a substantially square planar shape formed of four rectangular prisms bonded to each other, and on the substantially X-shaped interfaces on which the rectangular prisms are bonded to each other, there are formed dielectric multilayer films.

The projection optical device 6 projects the image light combined by the combining optical device 5 toward the screen SCR in an enlarged manner. The color image enlarged is displayed on the screen SCR. As the projection optical device 6, it is possible to use a combination lens constituted by, for example, a lens barrel, and a plurality of lenses disposed in the lens barrel.

Subsequently, a configuration of the illumination device 2 will be described.

The illumination device 2 is provided with a light source device 40, a wavelength conversion element 50, a collimating optical system 60, a first lens array 65, a second lens array 66, a polarization conversion element 70, and a superimposing lens 71.

As the light source device 40, it is possible to use any one of the light source devices according to the embodiments described above. The light source device 40 emits, for example, the blue pencil LA toward the wavelength conversion element 50.

The wavelength conversion element 50 is a so-called transmissive wavelength conversion element, and is formed of the single wavelength conversion layer 52 disposed in a part of a substrate 56 having a circular shape continuously along the circumferential direction of the substrate 56, wherein the substrate 56 can be rotated by an electric motor 58. The wavelength conversion element 50 converts the blue pencil LA into yellow fluorescence including red light and green light, and then emits the fluorescence toward the opposite side to the side which the blue pencil LA enters.

The substrate 56 is made of a material for transmitting the blue pencil LA. As the material of the substrate 56, there can be used, for example, silica glass, quartz crystal, sapphire, optical glass, and transparent resin.

The blue pencil LA from the light source device enters the wavelength conversion element 50 from the substrate 56 side. The wavelength conversion layer 52 is formed on the substrate 56 via a dichroic film 54 for partially transmitting the blue pencil LA and reflecting the fluorescence. The dichroic film 54 is formed of, for example, a dielectric multilayer film.

The wavelength conversion layer 52 converts a part of the blue pencil LA having the wavelength of about 445 nm emitted from the light source device 40 into the fluorescence YL, and then emits the fluorescence YL, and at the same time, transmits the remaining part of the blue pencil LA as blue light LA1 without converting. In other words, the wavelength conversion layer 52 is excited by the light emitted from the light source device 40 to emit the fluorescence.

In such a manner, it is possible to obtain the illumination light WL as the white light obtained by combining the blue light LA1 and the fluorescence YL with each other using the light source device 40 for emitting the excitation light and the wavelength conversion layer 52. The wavelength conversion layer 52 is formed of a layer including, for example, (Y, Gd)₃(Al, Ga)₅O₁₂: Ce as an example of a YAG phosphor, and an organic binder.

The collimating optical system 60 is provided with a first lens 61 and a second lens 62. The collimating optical system 60 substantially collimates the illumination light WL from the wavelength conversion element 50. The first lens 61 and the second lens 62 are each formed of a convex lens.

The first lens array 65 divides the illumination light WL from the collimating optical system 60 into a plurality of partial light beams. The first lens array 65 is formed of a plurality of first lenses 65a arranged in a matrix in a plane perpendicular to an illumination light axis ax.

The second lens array 66 is formed of a plurality of second lenses 66a arranged in a matrix in a plane perpendicular to an illumination light axis ax. The plurality of second lenses 66a is disposed corresponding to the plurality of first lenses 65a of the first lens array 65. The second lens array 66 forms the image of each of the first lenses 65a of the first lens array 65 in the vicinity of each of the image forming areas of the light modulation device 4R, the light modulation device 4G, and the light modulation device 4B in cooperation with the superimposing lens 71.

The polarization conversion element 70 is a polarization conversion element for converting each of the partial light beams divided into by the first lens array 65 into substantially unique linearly polarized light having a uniform polarization direction, and then emitting the resulted partial light beams. The polarization conversion element 70 has a polarization separation layer, a reflecting layer, and a wave plate not shown. The polarization separation layer transmits one of the linearly polarized components included in the light from the wavelength conversion element 50 without modification, and reflects the other of the linearly polarized components in a direction perpendicular to the illumination light axis ax. The reflecting layer reflects the other linearly polarized component, which has been reflected by the polarization separation layer, toward a direction parallel to the illumination light axis ax. The wave plate converts the other linearly polarized component having been reflected by the reflecting layer into the one linearly polarized component.

The superimposing lens 71 collects each of the partial light beams from the polarization conversion element 70 to thereby superimpose the partial light beams in the vicinity of each of the image forming areas of the light modulation devices 4R, 4G, and 4B.

The first lens array 65, the second lens array 66, and the superimposing lens 71 constitute an integrator optical system for homogenizing the in-plane light intensity distribution of the illumination light WL from the wavelength conversion element 50.

According to the projector 1 related to the fifth embodiment described hereinabove, the following advantages are exerted.

The projector 1 according to the fifth embodiment is provided with the illumination device 2, the light modulation devices 4B, 4G, and 4R, and the projection optical device 6, wherein the illumination device 2 includes the light source device 40, the light modulation devices 4B, 4G, and 4R modulate the blue light LB, the green light LG, and the red light LR obtained by separating the illumination light WL from the illumination device 2 in accordance with the image information to thereby form the image light, and the projection optical device 6 projects the image light. Due to the above, according to the projector 1 related to the fifth embodiment, since the illumination device 2 including the light source device 40 excellent in cooling performance of the light emitting elements is provided, it is possible to provide the projector which stably projects a high-intensity image and is high in reliability.

It should be noted that the scope of the present disclosure is not limited to the embodiments described above, but a variety of modifications can be provided thereto within the scope or the spirit of the present disclosure.

For example, there is shown an example in which the light emitting device is provided with the sub-mounts in the embodiments described above, but the light emitting device is not necessarily required to be provided with the sub-mounts. Further, regardless of the presence or absence of the sub-mounts, the emission direction of the light L from the plurality of light emitting elements 14 can be a direction perpendicular to the obverse surface 12a of the substrate 12, or can also be a direction parallel to the obverse surface 12a. As described above, when the emission direction of the light L is parallel to the obverse surface 12a of the substrate 12, it is sufficient to fold the light path of the light L from the light emitting element 14 using an optical element such as a prism to guide the light L to the lid body 16.

Further, the specific descriptions related to the specific configurations of the shape, the size, the number, the arrangement, the material and so on of a variety of members including the substrate, the light emitting elements, the frame body, the lid body, the support member, the light transmissive member and so on constituting the light source device are not limited to the embodiments described above, but can arbitrarily be modified.

Further, although in the embodiment described above, there is described the example when applying the present disclosure to the transmissive projector, the present disclosure can also be applied to a reflective projector.

Here, “transmissive” means that the liquid crystal light valve including the liquid crystal panel and so on has a configuration of transmitting the light. The term “reflective” means that the liquid crystal light valve has a configuration of reflecting the light. It should be noted that the light modulation device is not limited to the liquid crystal light valve, but it is also possible to use, for example, a digital micromirror device.

Further, although in the embodiment described above, there is cited the example of the projector using the three liquid crystal panels, the present disclosure can also be applied to a projector using one liquid crystal light valve alone or a projector using four or more liquid crystal light valves.

Further, although in the embodiment described above, there is described the example of installing the light source device according to the present disclosure in the illumination device for the projector, this is not a limitation. The light source device according to the present disclosure can also be applied to lighting equipment, a headlight of a vehicle, and so on.

What is claimed is:

1. A light source device comprising:
a light emitting device including a substrate having a first surface and a second surface disposed at an opposite side to the first surface, a plurality of light emitting elements disposed at the first surface side of the substrate, a frame body disposed at the first surface side of the substrate so as to surround the plurality of light emitting elements, and a lid body including a light transmissive member configured to transmit light emitted from the plurality of light emitting elements, disposed so as to be opposed to the first surface of the substrate, and bonded to an opposite side of the frame body to the substrate, and configured to house the plurality of light emitting elements in a housing space formed of the substrate, the frame body, and the lid body;
an optical element which the light enters;
a holding member configured to hold the optical element; and
a heat radiation member thermally coupled to the second surface of the substrate, and fixed to the holding member.

2. The light source device according to claim 1, wherein
a surface at an emission direction side of the light of the substrate touches the holding member,
a substrate is fixed to the holding member, and
a part of the substrate is sandwiched between the holding member and the heat radiation member.

3. The light source device according to claim 1, wherein
the second surface of the substrate touches the holding member.

4. The light source device according to claim 1, wherein
the substrate is fixed to the heat radiation member, and
a part of the substrate is sandwiched between the holding member and the heat radiation member.

5. A projector comprising:
the light source device according to claim 1;
a light modulation device configured to modulate light emitted from the light source device in accordance with image information; and
a projection optical device configured to project the light modulated by the light modulation device.

6. A projector comprising:
the light source device according to claim 2;
a light modulation device configured to modulate light emitted from the light source device in accordance with image information; and
a projection optical device configured to project the light modulated by the light modulation device.

7. A projector comprising:
the light source device according to claim 3;
a light modulation device configured to modulate light emitted from the light source device in accordance with image information; and
a projection optical device configured to project the light modulated by the light modulation device.

8. A projector comprising:
the light source device according to claim 4;
a light modulation device configured to modulate light emitted from the light source device in accordance with image information; and
a projection optical device configured to project the light modulated by the light modulation device.
